(19) United States
(12) Patent Application Publication
(10) Pub. No.: US 2022/0321623 A1
(43) Pub. Date: Oct. 6, 2022

(54) ESTABLISHING A PRODUCER / CONSUMER SESSION IN THE CLOUD

(71) Applicant: Ademco Inc., Golden Valley, MN (US)

(72) Inventors: Piotr Romanczyk, Melville, NY (US); William R. Blum, Huntington Station, NY (US)

(21) Appl. No.: 17/222,000

(22) Filed: Apr. 5, 2021

(51) Int. Cl. H04L 29/06; H04N 7/14

(52) U.S. Cl. CPC H04L 65/4084; H04L 65/4092; H04N 7/147

(57) ABSTRACT

A cloud computing platform includes a streamer farm comprising streamers, a load balancer, and a command service. The command service can be configured to receive a request from a consumer application for streaming data from a producer device configured to provide streaming data, relay the request to the producer device, receive a response from the producer device including an address of at least one streamer the load balancer selects, and relay the address to the consumer application to enable the consumer application to retrieve the requested streaming data. A method of establishing a producer/consumer session in a cloud computing platform includes receiving a request from a consumer application for streaming data, communicating with a producer to provide the streaming data to a streamer of a streamer farm selected by a load balancer, receiving and address of the streamer, and providing the address to the consumer application.

### TECHNICAL FIELD

This disclosure relates generally to network communications. For example, embodiments disclosed herein include a cloud computing platform that can be configured, for instance, to establish a producer/consumer session.

### BACKGROUND

A consumer application may request content, such as video data produced by a producer device, from the internet. While the content produced by the producer device may be stored in one or more servers (e.g., in the cloud) before the consumer application requests the content, in some instances, the content has not yet been produced. In some such instances, the consumer device requests the content with the producer device needing to receive the request to start producing content.

The producer device may store the content in one or more servers connected to the internet to enable multiple consumer applications to receive the content produced by the producer device at substantially the same time. However, it can be difficult to ensure that the consumer applications do not try to consume data which has yet to be produced by the producer device. Further, it can be desirable to decrease the complexity of establishing communication between the producer device, the one or more servers storing content produced by the producer device, and the consumer application(s) requesting the content.

### SUMMARY

This disclosure in general describes a cloud computing platform that establishes a producer/consumer session in the cloud. In particular, embodiments disclosed herein enable a consumer application to retrieve data provided by a producer device to at least one streamer. In one such example, embodiments disclosed herein can include a streamer farm comprising two or more streamers, a load balancer configured to select at least one of the two or more streamers to store streaming data, and a command service. In some embodiments, the command service can be configured to receive a request from a consumer application to request streaming data from a producer device configured to provide streaming data. The command service can be further configured to relay the request to provide the requested streaming data to the producer device. The command service can also be configured to receive a response from the producer device that includes an address of the at least one of the two or more streamers that the load balancer selects to store the requested streaming data. Additionally, the command service can be configured to relay the address to the consumer application to enable the consumer application to retrieve the requested streaming data from the selected at least one streamer.

In comparison to previous systems, embodiments of present disclosure are more deterministic and do not require custom components. For example, embodiments of the present disclosure can include “off the shelf” components (e.g., command service server, load balancer), which can reduce complexity and cost and can improve reliability. Further, embodiments of the present disclosure can prevent a consumer application from attempting to consume content that has yet to be produced by a producer device.

The present disclosure describes various embodiments. One embodiment includes a cloud computing platform comprising a streamer farm comprising two or more streamers, a load balancer configured to select at least one of the two or more streamers to store streaming data, and a command service. The command service can be configured to receive a request from a consumer application to request streaming data from a producer device configured to provide streaming data. The command service can also be configured to relay the request to provide the requested streaming data to the producer device. Further, the command service can be configured to receive a response from the producer device that includes an address of the at least one of the two or more streamers that the load balancer selects to store the requested streaming data. Additionally, the command service can be configured to relay the address to the consumer application to enable the consumer application to retrieve the requested streaming data from the selected at least one streamer.

One embodiment includes a method. This method embodiment includes receiving a request from a consumer application for streaming data with the streaming data provided by a producer device. The method also includes communicating with the producer device to provide the requested streaming data to a load balancer with the load balancer communication with multiple streamers in a streamer farm to select a streamer to store the requested streaming data. The method further includes receiving a response from the producer device that includes an address of the selected streamer. Additionally, the method includes providing the address to the consumer application to enable retrieval of the requested streaming data.

Another embodiment includes a method of establishing a producer/consumer session in a cloud computing platform. The method includes receiving a request from a consumer application for streaming data with the streaming data provided by a producer device and relaying the request for streaming data to the producer device. The method also includes receiving the requested streaming data at a load balancer with the load balancer communicating with one or more streamers of a streamer farm to determine which of the one or more streamers should store the requested streaming data. The method further includes receiving, from the one or more of the streamers storing the requested streaming data, an address of the one or more streamers storing the requested streaming data. Additionally, the method includes relaying the address of the one or more streamers to the producer device, receiving the address of the one or more streamers from the producer device, and relaying the address of the one or more streamers to the consumer application.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is a block diagram of an embodiment of a cloud computing platform including a producer device, a consumer application, and various connections therebetween.

FIG. 2 is a flow diagram of an example method of establishing a producer/consumer session in a cloud computing platform according to an aspect of the present disclosure

FIG. 3 is a flow diagram of an example method of establishing a producer/consumer session in a cloud computing platform according to an aspect of the present disclosure.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

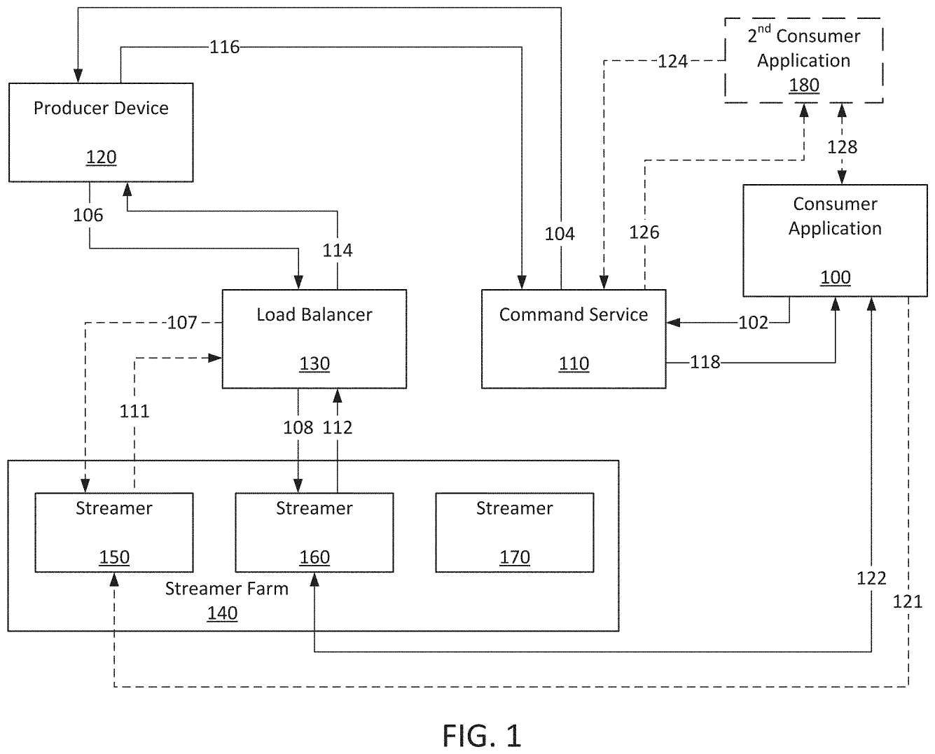

FIG. 1 shows one embodiment of a cloud computing platform including a consumer application 100, a producer device 120, and various connections therebetween. In FIG. 1, the consumer application 100 can request data, such as streaming data, from the producer device 120. The producer device 120 may not be producing data until such time as it receives a request to start producing data, for example, from the consumer application 100. As the consumer application 100 may not be directly connected to the producer device 120, the consumer application 100 can be connected indirectly to the producer device 120 via the internet. In some instances, the internet is referred to as a cloud, which can comprise computer servers and other computer hardware. In some example operations, the cloud computing platform of FIG. 1 can enable a consumer application 100 to retrieve streaming data produced by a producer device 120 from at least one streamer of a streamer farm 140 using a command service 110 and a load balancer 130.

The embodiment of FIG. 1 includes a consumer application 100, a command service 110, a producer device 120, a load balancer 130, and a streamer farm 140 comprising two or more streamers 150, 160, 170 along with the connections therebetween. In some embodiments, a second consumer application 180 is included in the cloud computing platform of FIG. 1.

The consumer application 100 of FIG. 1 can take many forms. In some embodiments, the consumer application 100 can be a computer program which can send, request, and receive data (e.g., streaming data) such as to and/or from the cloud. In some embodiments like the example of FIG. 1, the consumer application 100 can request streaming data from a producer device 120 and once it receives the streaming data, it can use the streaming data for various applications. For example, the consumer application can be a security application which is connected to the internet and can request streaming data, such as video streaming data, in order to display the video streaming data to a user of the consumer application 100. In another example, the consumer application can request streaming data (e.g., video streaming data) from the producer device and use received streaming data to identify persons in the streaming data. In some such embodiments, the consumer application can provide a notification, alert, or other communication if a person is identified in the streaming data. In some embodiments, the consumer application is a mobile application which can be configured to display streaming data. A person having skill in the art will appreciate that other types of consumer applications are contemplated, and that the disclosure is not limited to the examples described herein.

The producer device 120 of FIG. 1 can be any device which produces streaming data. However, in some embodiments, the producer device 120 is a device which produces video streaming data such as a camera or video camera. For example, the producer device can be a security video camera that can generate video image data. In some embodiments, the producer device 120 can produce audio streaming data in addition to or in lieu of video streaming data. In some embodiments, the producer device can be a sensor which is capable of producing a continuous stream of data. A continuous stream of data can be of interest to a consumer that desires to consumer the stream of data in real time. For instance, in some examples, the producer device can include a geolocational sensor which can provide continuous geolocational streaming data (e.g., GPS). In some embodiments, the producer device can comprise at least one of a microphone, a proximity sensor, a GPS, and a server. The server can be a device or series of devices which produce data including but not limited to: stock market trading data, retail inventory management data, game streaming data, traffic data, and pricing data. Other examples of devices, sensors, and/or servers which produce streaming data, including continuous streaming data, are contemplated.

In order to request streaming data from the producer device 120, the consumer application 100 can be in communication with the producer device 120 via a command service 110. The command service 110 can comprise one or more command servers that can be located remotely from the consumer application 100. Additionally or alternatively, the command service 110 can comprise computer hardware that is configured to perform the functions of the command service 110 as described herein. In some embodiments, the command service 110 comprises command servers that are readily available and that require little to no modification to perform the specified functions of the command service 110. With little to no modification required for the command service, the reliability and simplicity of the cloud computing platform can be increased. The command service 110 can be configured to receive commands and can further relay the received commands to various other devices and/or applications. In some embodiments, the command service 110 can be configured to receive and relay requests, such as requests for streaming data. The command service 110 can handle any number of requests and can be configured to receive and relay multiple requests simultaneously. In some embodiments, the command service 110 can process requests it receives in addition to relaying requests.

In the embodiment of FIG. 1, the command service 110 can receive a command, such as a request for streaming data from the producer device 120, from the consumer application 100 as shown by arrow 102. The command service can optionally process the request for streaming data before the command service relays the request for streaming data to the producer device 120 as shown by arrow 104. Through the communication between the consumer application, the command service, and the producer device, the consumer application 100 can send requests for streaming data, to be provided by the producer device, using the command service 110. Using a command service can be advantageous as in some embodiments, connecting the consumer application 100 directly to the producer device 120 (e.g., direct connection via the internet) can be insecure.

However, in some embodiments, the consumer application 100 can be in further communication with the producer device 120. In some embodiments, the consumer application 100 is in communication with the producer device 120 via the command service 110. Alternatively, in some embodiments, the consumer application 100 is in communication with the producer device 120 via the internet or other connection. The further communication between the consumer application 100 and the producer device 120 can enable the consumer application 100 to send command signals to the producer device to control various aspects of the producer device 120. For example, the producer device 120 can be a security device such as a security camera with the consumer application 100 in communication with the security device. The consumer application can be enabled by the further communication between it and the security camera such that it can control the direction, zoom, and other aspects of the security camera.

Continuing with the embodiment of FIG. 1, the producer device 120 is a device configured to provide streaming data. The producer device 120 can generate streaming data and can provide the streaming data to other components of the cloud computing platform of FIG. 1. For example, the producer device 120 can provide streaming data to a load balancer 130. In some embodiments, the producer device 120 can be configured to provide streaming data to a consumer application 100 by using other components of a cloud computing platform including the load balancer 130 and a streamer farm 140.

The producer device 120 can comprise any device that is configured to provide streaming data, however, in some embodiments, the producer device 120 is an imaging device (e.g., video camera) that is configured to provide video streaming data. Other devices are contemplated including an audio device configured to provide audio streaming data. In some embodiments, the producer device 120 can comprise a device that is configured to provide streaming data in the form of both audio and visual streaming data. For example, the producer device 120 can be a video camera with integrated microphone (e.g., a security camera) that can be configured to provide audio and visual streaming data.

The producer device 120 can have different modes of operation including a state in which the producer device 120 provides data and a state in which the producer device 120 does not provide data. Further, the producer device 120 can switch between states and, in some embodiments, the producer device 120 can switch between states in response to an external signal. For example, the producer device 120 can initially be in an off state or sleep state in which it does not provide streaming data, but can switch states to an on state or active state in which it provides streaming data, after it receives a request from the command service 110 for streaming data.

In an example operation of the embodiment of FIG. 1, the producer device 120 can receive a request to provide streaming data from the command service 110 as shown by arrow 104. Once the request has been received, the producer device 120 can generate and provide streaming data to the load balancer 130 as shown by arrow 106.

Continuing with the embodiment of FIG. 1, the cloud computing platform includes a load balancer 130. The load balancer 130 can comprise hardware and/or software configured to receive streaming data and direct the streaming data. For example, the load balancer 130 can comprise one or more servers programmed to direct streaming data. In operation, the load balancer 130 can direct received streaming data (e.g., from producer device 120) to at least one streamer of a streamer farm. As illustrated in the embodiment of FIG. 1, the load balancer 130 of FIG. 1 is in communication with two or more streamers 150, 160, 170 of a streamer farm 140. The load balancer 130 can be in constant communication with each of the two or more streamers 150, 160, 170 in order to select at least one of the two or more streamers to store streaming data. By staying in constant communication, the load balancer 130 can determine which of streamers of the streamer farm 140 are best suited to receive and store streaming data. Some example criteria which the load balancer can use to determine which streamer is best suited to receive and store streaming data include streamer health, streamer capacity, and streamer latency. For example, a first streamer 150 of a streamer farm may be unable to process or store new streaming data due to insufficient capacity while a third streamer 170 may have poor health. In such an example, the load balancer can select a second streamer 160 to receive streaming data. As the load balancer 130 can be in constant communication with the streamers 150, 160, 170, the load balancer 130 can continually select the best suited streamer based on the criteria (e.g., streamer capacity) received from the streamers. Thus, the load balancer can balance the load (e.g., streaming data) between different streamers of a streamer farm and ensure the streaming data is received by and stored on the best suited streamer. The load balancer can employ other methods to balance the load between different streamers of a streamer farm including but not limited to choosing the first available streamer (e.g., without regard to other conditions) and choosing a streamer based on algorithms for selecting the best suited streamer. In some embodiments, the load balancer comprises hardware and/or software which is readily available and which require little to no modification to perform the specified functions of the load balancer. With little to no modification required, the reliability and simplicity of the cloud computing platform can be increased.

In some embodiments, the load balancer 130 can be configured to select two or more streamers of a streamer farm to receive streaming data. In some such embodiments, the load balancer 130 can split the streaming data such that a portion of the streaming data is stored on one of the two or more streamers and another portion of the streaming data is stored on a different one of the two or more streamers. For example, the load balancer can be configured to select a first streamer (e.g., 150) of a streamer farm (e.g., 140) to store visual streaming data and can further be configured to select a second streamer (e.g., 170) of a streamer farm to store audio streaming data. Thus, the first streamer would store visual streaming data and the seconds streamer would store audio streaming data. By splitting the streaming data received from the producer device 120, the load balancer can more effectively balance the load among the first streamer, the second streamer, and any other streamers of a streamer farm. For instance, as visual streaming data can require more resources to store than audio streaming data, the audio streaming data can be stored on a streamer with less capacity while the visual streaming data is stored on a streamer with more capacity. In some embodiments, the load balancer can be configured to store portions of visual and/or audio streaming data in a first streamer of a streamer farm and store remaining portions of the visual and/or audio streaming data in a second streamer of a streamer farm. For example, visual streaming data can be evenly split and stored between a first streamer and a second streamer. By splitting the streaming data between streamers, the streaming data can be stored more evenly and the load on the streamers can be more easily balanced.

As discussed, the load balancer can select at least one streamer of a streamer farm to store streaming data. In the embodiment of FIG. 1, for example, the load balancer 130 is selected to provide streaming data to streamer 160 of the streamer farm 140 as shown by arrow 108. The streamer farm 140 of FIG. 1 comprises three streamers 150, 160, 170 for receiving and storing streaming data. While in some embodiments, the streamer farm can comprise a single streamer, in such embodiments a load balancer may not be needed as any streaming data produced by the producer device is only able to be stored by the single streamer. Thus, in some preferred embodiments, the streamer farm 140 includes at least two streamers.

The streamers 150, 160, 170 of the streamer farm 140 can comprise hardware and software configured to receive and store streaming data. For example, in some embodiments, the streamers comprise computer servers with computer memory (e.g., flash memory, hard disk drives) which can store streaming data. Additionally or alternatively, in some embodiments, the streamers comprise virtual machines (VMs) which have access to computer memory (e.g., flash memory, hard disk drives, RAM, ROM) to store streaming data. In some such embodiments, the streamer farm 140 can comprise a single server with each of the streamers being a VM running on the single server.

Each of the streamers 150, 160, 170 of the streamer farm 140 can include an address which can be used to differentiate one streamer from another. In some embodiments, the address is an internet protocol (IP) address. For example, in the embodiment of FIG. 1, streamer 150 can have a first IP address, streamer 160 can have a second IP address, and streamer 170 can have a third IP address, with each of the IP addresses being different from one another. In some embodiments, the streamer farm 140 itself can have an address separate from the streamers' addresses. While the addresses can stay the same, in some embodiments, the addresses can change. The addresses can be used by other components of the cloud computing platform to identify the individual streamers of the streamer farm. The load balancer 130, for instance, can receive each of the addresses of the streamers 150, 160, 170 of the streamer farm 140. By staying in constant communication with the streamers, the load balancer 130 can determine the individual addresses of the streamers of the streamer farm even if they change.

As shown by arrows 108 of FIG. 1, the load balancer 130 can select the streamer 160 to receive and store streaming data. In some embodiments, the streamer 160 can communicate with the load balancer 130. For example, the streamer can communicate with the load balancer 130 to confirm that it is receiving or has received streaming data sent to it by the load balancer 130. In some embodiments, the streamer 160 can communicate its address (e.g., direct address) to the load balancer 130 to be relayed to the producer device 120 as shown by arrow 112. In such embodiments, the load balancer 130 can receive an address of the streamer that the load balancer 130 selected to store the streaming data. The load balancer can 130 can also provide the address to other parts of the cloud computing platform such that the address is eventually relayed to the consumer device. In some embodiments, internet transport protocols are used to relay the address of the selected streamer through the components of the cloud computing platform including the load balancer.

As discussed elsewhere herein, in some embodiments, streaming data can be stored in at least one streamer of a streamer farm. When streaming data is stored in more than one streamer, the addresses (e.g., direct addresses) of the streamers that store the streaming data can be received by the load balancer and sent to other components of the cloud computing platform. For example, video streaming data can be stored on a first streamer (e.g., 160) having a first address and audio streaming data can be stored on a second streamer (e.g., 140) having a second address. In such an example, the first streamer having the first address can pass the first address to the consumer device through the load balancer, the producer device, and the command service while the second streamer having the second address can also pass the second address to the consumer device in a similar manner. For instance, in FIG. 1, a first streamer having a first address can be streamer 150 with arrow 107 representing streaming data being directed to the streamer 150 and with arrow 111 representing an address of the streamer being passed through the load balancer 130. Similarly in FIG. 1, a second streamer having a second address can be streamer 160 with arrow 108 representing streaming data being directed to the streamer 150 and with arrow 112 representing an address of the streamer being passed through the load balancer 130. Once the first address and the second address are received, the consumer device can use the addresses of the first streamer and the second streamer to access and consume the streaming data stored on the first streamer and the second streamer. For example, in FIG. 1, the consumer application 100 can access and consume the streaming data stored on a first streamer 150 as shown by arrow 121 and the consumer application 100 can access and consume the streaming data stored on a second streamer 160 as shown by arrow 122.

Continuing with the embodiment of FIG. 1, the address of streamer 160 that is storing streaming data provided by the producer device 120 can be sent from the load balancer to the producer device 120 as shown by arrow 114. The producer device 120, after receiving the address of the streamer 160 which is storing the streaming data, can further send the address of the streamer to the command service 110 as shown by arrow 116. Similarly, the command service 110, after receiving the address of the streamer 160 which is storing the streaming data, can send the address of the streamer to the consumer application 100 as shown by arrow 118. Once the consumer application 100 has received the address of the streamer 160, it can use the address to connect to the streamer 160 as shown by arrow 122. Additionally, once connected, the streamer 160 can send the streaming data produced by the producer device 120 to the consumer application 100 where the streaming data can be consumed. In some embodiments, the address of the selected streamer can be stored on a component of the cloud computing platform for later use. For example, the producer device can store the streamer address to which it is providing streaming data.

In some embodiments, after the consumer application has received the address of the selected streamer, the consumer application can be configured to provide a notification that it has received the address. The notification can alert a user of the consumer application that the consumer application can connect to the selected streamer in order to consume or otherwise use the streaming data.

However, while the streaming data is sent from one or more streamers to the consumer application 100, the streaming data can also be retained by the one or more streamers. For example, in some embodiments, a copy of the streaming data that is stored on a streamer can be sent to the consumer application to be consumed instead of the streaming data itself. In some such embodiments, the streaming data stored on the streamer can be accessed and consumed later and/or by another consumer application.

By routing the address of the streamer 160 from the load balancer 130, to the producer device 120, to the command service 110, and to the consumer application 100, the cloud computing platform can avoid asynchronous operations with the command service 110. For example, the consumer application 100 does not and cannot receive the address of the streamer that the producer device 120 is providing streaming data to before the producer device has actually produced the streaming data. Further, routing the address of the streamer 160 as in FIG. 1 enables the cloud computing platform to be efficient and deterministic.

In some embodiments, the consumer application 100 of FIG. 1 can be in communication with the producer device 120 via a streamer (e.g., 160) and the load balancer 130. In such embodiments, the consumer application 100 can send data, such as audio and/or visual data, to the streamer of which it has the address. As the load balancer 130 can be in constant communication with the streamers of the streamer farm 140, it can receive data from the streamer and can relay the information to the producer device 120. In some embodiments, the load balancer uses the same connection which it uses to receive streaming data from the producer device 120. In some examples, the connection between the consumer application 100 and the producer device 120 through the selected streamer and the load balancer 130 can enable two-way communication (e.g., bi-directional audio communication) between the respective components. In some such examples, the producer device can receive consumer data from the consumer application and the consumer application can receive streaming data form the producer device.

The embodiment of FIG. 1 can also include a second consumer application 180. The second consumer application 180 can be in communication with the command service 110 in a similar manner to the consumer application 100. In an example operation in which the consumer application 100 has already received the address of the streamer 160 which is storing the streaming data produced by the producer device 120, the second consumer application 180 can request the streaming data from the producer device 120 via the command service 110 as shown by arrow 124. In such an example, the command service 110 can receive and route the request for streaming data from the second consumer application 180 to the producer device 120 in a similar manner as it receives and routes the request for streaming data from the consumer application 100. However, as the producer device 120 already has the address of the streamer 160 storing the streaming data, the producer device 120 can send the address to the command service 110. The command service 110 can receive the address of the streamer 160 and can provide the address to the second consumer application 180 to enable retrieval of the streaming data which the second consumer application 180 requested as shown by arrow 126. Through such configurations, the second consumer application 180 and any subsequent consumer applications can establish a connection and receive streaming data from a selected streamer without involving the cloud load balancer or the connections between the producer, cloud load balancer, and the streamer of the streamer farm; thereby increasing efficiency and decreasing latency.

In addition to the consumer application 100 and the second consumer application 180, the cloud computing platform can comprise a dependent consumer application that is in communication with the consumer application 100 as shown by arrow 128. In an example operation, after the consumer application 100 receives the address of the streamer 160, which is storing the streaming data produced by the producer device 120, the consumer application 100 can provide the address to the dependent consumer application. Once the dependent consumer application has received the address of the streamer 160, the dependent consumer application can use the address to retrieve and consume the streaming data stored on the streamer 160. In such operations, the dependent consumer application does not have to communicate with the producer device 120, the command service 110, or the load balancer 130 and can immediately consume streaming data from a streamer (e.g., 160) after receiving the address of the streamer from the consumer application 100.

While the embodiment of FIG. 1 depicts multiple arrows connecting the various components of the cloud computing platform, the arrows can be representative of single or multiple connections. For example, a single connection can connect the producer device 120 to the load balancer 130. Further, the embodiment of FIG. 1 does not necessarily include all the components and connections between the illustrated components. For example, one or more load balancers, which are not load balancer 130, can be connected between the command service 110 and the producer device 120. A person having ordinary skill will appreciate the illustrated components and connections are not the only components and connections which can be a part of a cloud computing platform.

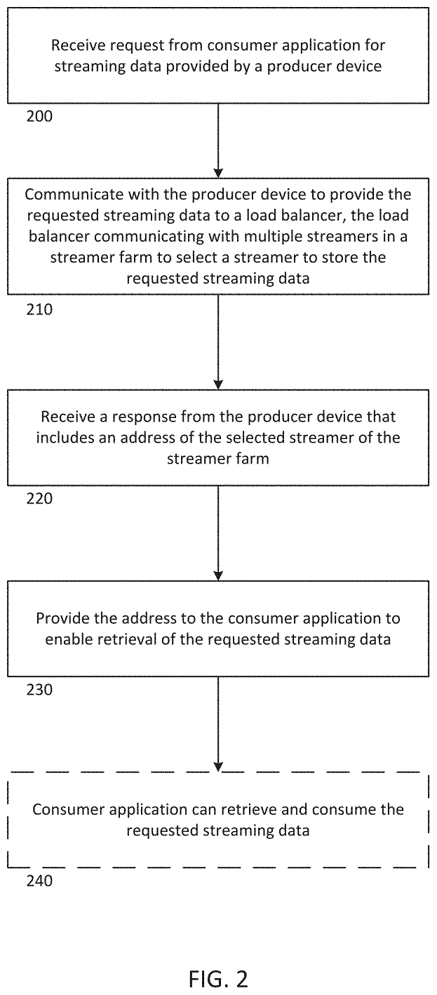

Moving to the embodiment of FIG. 2, FIG. 2 is a flow diagram of an example method of establishing a producer/consumer session in a cloud computing platform according to an aspect of the present disclosure. In the embodiment of FIG. 2, a command service can be configured to perform the method, however, a person of ordinary skill will appreciate the method can be performed by other means. Starting at step 200, the method includes receiving a request from a consumer application for streaming data provided by a producer device. At step 210, the method further includes communicating with the producer device to provide the request streaming data to a load balancer. The load balancer can be in communication with multiple streamers of a streamer farm and can be configured to select a streamer to store the requested streaming data. Additionally, the method includes receiving a response from the producer device that includes an address of the selected streamer of the streamer farm which stores the requested streaming data as in step 220. The method also includes providing the address of the selected streamer to the consumer application to enable retrieval of the requested streaming data from the selected streamer as in step 230. Optionally, as in step 240, the method can include the consumer application retrieving and consuming the requested streaming data from the selected streamer. As illustrated in the method of FIG. 2, a producer/consumer session is established whereby streaming data, requested by a consumer application and provided by a producer device, is able to be consumed by the consumer application via a streamer of a streamer farm. While only one streamer is described as storing streaming data provided by the producer device, in some embodiments, more than one streamer can store streaming data. In some such embodiments, the addresses of the streamers can be provided to the consumer application to enable retrieval of the requested streaming data from the streamers.

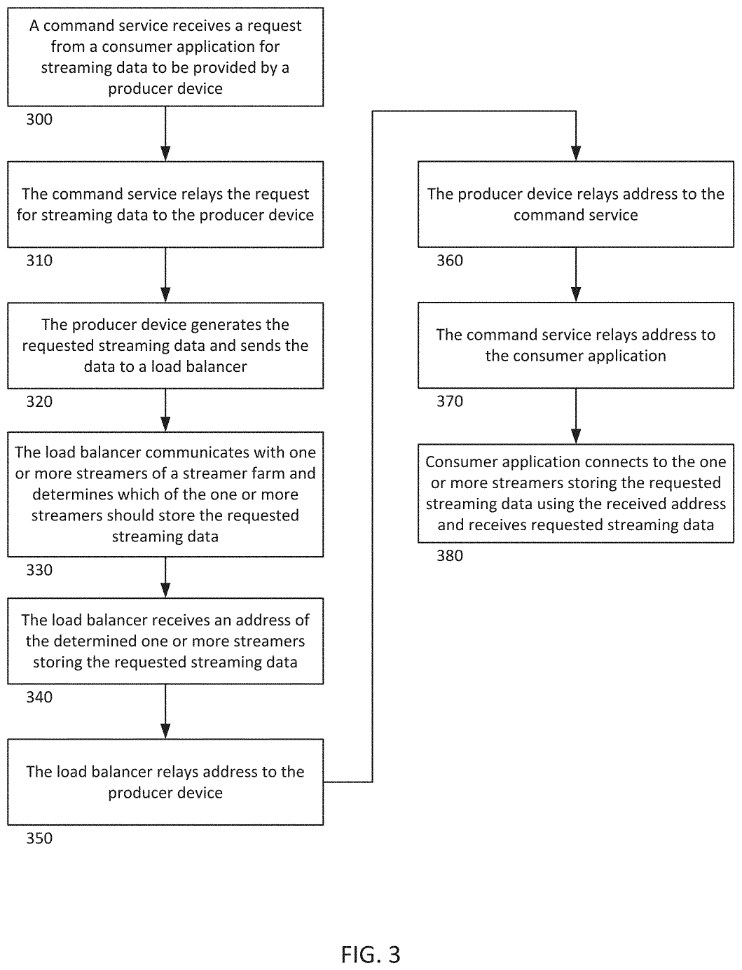

FIG. 3 is a flow diagram of an example method of establishing a producer/consumer session in a cloud computing platform according to an aspect of the present disclosure. In step 300, a command service receives a request from a consumer application for streaming data to be provided by a producer device. The command service then relays the request for streaming data to the producer device at step 310. The producer device can, after receiving the request for streaming data, generate the requested streaming data and send the data to a load balancer as in step 320. At step 330, the load balancer communicates with one or more streamers of a streamer farm and determines which of the one or more streamers should store the requested streaming data. Continuing with step 340, the load balancer then receives an address of the one or more streamers storing the requested streaming data. While one or more streamers can be used to store the streaming data provided by the producer device, in some embodiments, a single streamer stores the streaming data. The address can be relayed by the load balancer to the producer device, then relayed from the producer device to the command service, and relayed from the command service to the consumer application as in steps 350, 360, and 370. The consumer application can then connect to the one or more streamers storing the requested streaming data using the received address and can further receive and/or consume the requested streaming data as in step 380. Thus, a producer/consumer session is established with the consumer application receiving the streaming data provided by the producer device.

Various examples have been described. These and other examples are within the scope of the following claims.

1. A cloud computing platform comprising:
a streamer farm comprising two or more streamers;
a load balancer configured to select at least one of the two or more streamers to store streaming data; and
a command service configured to:
(a) receive a request from a consumer application to request streaming data from a producer device configured to produce streaming data;
(b) relay the request to produce the requested streaming data to the producer device;
(c) receive a response from the producer device that includes an address of the at least one of the two or more streamers that the load balancer selects to store the requested streaming data; and
(d) relay the address to the consumer application to enable the consumer application to retrieve the requested streaming data from the selected at least one streamer.

2. The cloud computing platform of claim 1, wherein the producer device is a camera device configured to produce the requested streaming data.

3. The cloud computing platform of claim 2, wherein the requested streaming data comprises at least one of visual data and audio data.

4. The cloud computing platform of claim 1, wherein the producer device is a security device and wherein the consumer application can send command signals to the producer device to control aspects of the security device.

5. The cloud computing platform of claim 1, wherein the consumer application is configured to provide a notification that it has received the address of the selected at least one streamer storing streaming data.

6. The cloud computing platform of claim 1, wherein the consumer application is configured to provide the address to a second application to enable retrieval of the streaming data by the second application.

7. The cloud computing platform of claim 1, further comprising a second consumer application, wherein the command service is further configured to (e) receive a request from the second consumer application for the requested streaming data produced by the producer device, (f) ask the producer device to provide the address of the selected at least one streamer, (g) receive the address of the selected at least one streamer from the producer device, and (h) provide the address to the second consumer application to enable retrieval of the requested streaming data.

8. The cloud computing platform of claim 1, wherein the consumer application is configured to send the address to a dependent consumer application.

9. The cloud computing platform of claim 8, wherein the streaming data comprises visual data and audio data.

10. The cloud computing platform of claim 9, wherein the load balancer is configured to select a first streamer for storing the visual data and a second streamer for storing the audio data.

11. The cloud computing platform of claim 1, wherein the consumer application is configured to generate consumer data that is relayed to the producer device via the streamer farm and the load balancer.

12. The cloud computing platform of claim 1, wherein the consumer application is a mobile application and is configured to display the streaming data.

13. A method of establishing a producer/consumer session in a cloud computing platform comprising:
receiving a request from a consumer application for streaming data, the streaming data produced by a producer device;
communicating with the producer device to provide the requested streaming data to a load balancer, the load balancer communicating with multiple streamers in a streamer farm to select a streamer to store the requested streaming data;
receiving a response from the producer device that includes an address of the selected streamer; and
providing the address to the consumer application to enable retrieval of the requested streaming data.

14. The method as in claim 13, wherein the producer device is a camera device configured to generate visual streaming data.

15. The method as in claim 13, wherein the consumer application and the producer device are in bidirectional communication whereby streaming data is retrieved by the consumer application and consumer data is retrieved by the producer device via the streamer selected by the load balancer.

16. The method of claim 13, wherein the producer device comprises at least one of a microphone, a proximity sensor, a GPS, and a server.

17. A method of establishing a producer/consumer session in a cloud computing platform comprising:
receiving a request from a consumer application for streaming data, the streaming data produced by a producer device;
relaying the request for the streaming data to the producer device;
receiving the requested streaming data at a load balancer, the load balancer communicating with one or more streamers of a streamer farm to determine which of the one or more streamers should store the requested streaming data;
receiving, from the one or more streamers storing the requested streaming data, an address of the one or more streamers storing the requested streaming data;
relaying the address of the one or more streamers to the producer device;
receiving the address of the one or more streamers from the producer device; and
relaying the address of the one or more streamers to the consumer application.

18. The method as in claim 17, wherein the address is provided to the consumer application after the streaming data is stored on the one or more streamers selected by the load balancer.

19. The method as in claim 17, further comprising:
receiving a request from a second consumer application for the streaming data produced by the producer device;
communicating with the producer device to provide the address of the streamer selected by the load balancer to store the requested streaming data;
receiving the address of the selected streamer; and
providing the address to the second consumer application to enable retrieval of the requested streaming data.

20. The method as in claim 17, wherein the producer device comprises at least one of an imaging device, a microphone, a proximity sensor, a GPS, and a server.
